(19) United States
(12) Patent Application Publication
(10) Pub. No.: US 2014/0290368 A1
(43) Pub. Date: Oct. 2, 2014

(54) METHOD AND APPARATUS FOR REMOTE POSITION TRACKING OF AN INDUSTRIAL ULTRASOUND IMAGING PROBE

(71) Applicant: Siemens Energy, Inc., Orlando, FL (US)

(72) Inventors: Yan Guo, Orlando, FL (US); Kevin P. Bailey, Chuluota, FL (US); Joshua S. McConkey, Orlando, FL (US)

(73) Assignee: Siemens Energy, Inc., Orlando, FL (US)

(21) Appl. No.: 14/206,411

(22) Filed: Mar. 12, 2014

Related U.S. Application Data
(60) Provisional application No. 61/805,979, filed on Mar. 28, 2013.

(51) Int. Cl. G01N 29/24; G01N 29/44

(52) U.S. Cl. CPC G01N 29/24; G01N 29/44
USPC 73/602

(57) ABSTRACT

A freestanding ultrasonic probe or transducer position relative to the inspected object is remotely tracked with a wireless transmitter/receiver or an optically based positioning system. Either type of positioning system generates a time stamped or commonly clocked positional data set that are sent to a post data processing module. The post data processing module creates a 3-D model of the inspected object, including location and size of indications in the inspected object, utilizing the positional data and inspection data generated by an ultrasonic testing instrument coupled to the freestanding probe/transducer.

### CROSS-REFERENCE TO RELATED APPLICATIONS

This application claims the benefit of co-pending U.S. provisional patent application entitled “WIRELESS 4D ULTRASONIC INSPECTION SYSTEM FOR NON-DESTRUCTIVE INSPECTION” filed Mar. 28, 2013 and assigned Ser. No. 61/805,979, which is incorporated by reference herein.

### BACKGROUND OF THE INVENTION

1. Field of the Invention

The invention relates to an industrial ultrasound system for non-destructive inspection of objects that do not have known internal and external positional structural information. The ultrasound system has an ultrasonic transducer or probe that is capable of free selective movement about a scanned object. Probe position is tracked remotely by a wireless transmitting or optical position location system, without an external probe positioning system, such as a motion control positioning system.

2. Description of the Prior Art

Known industrial ultrasound non-destructive evaluation (NDE) systems utilize probes that transmit ultrasonic waves through a test object and receive the echo wave with a transducer, such as a single crystal or phased array transducer, to generate ultrasonic inspection data. For brevity, the ultrasonic probe instrument, including the transducer it referred to a probe. The inspection data are routed to an ultrasound testing instrument via a hardwired cable. The ultrasonic testing instrument converts the inspection data into scan pattern that may be inspected visually in raw form. Scan pattern data may be processed in conjunction with scan pattern positional data in a post processing module to construct a 3-D model of the scanned object. The known industrial ultrasound probes are not capable of determining probe 3-D spatial location relative to the test object or correlating ultrasonic inspection data with spatial location. Spatial location information is obtained independent of the scan data by coupling the probe/transducer to a separate motion control system that is capable of moving the probe/transducer and indirectly indicating its positional data based on the motion control system's internal position encoder data. The post processing module has to combine the scan and positional data sets to generate a 3-D image of the scanned object. Motion control systems used to move the transducer are relatively expensive and inconvenient to transport and assemble in field locations. The motion control systems do not readily facilitate human intervention within a scanning cycle to reorient the transducer to a selected location. For example, during inspection it is desirable for an inspection technician to want to focus on a particular area of interest of the test object, but the motion control system will not readily permit the technician to move the probe easily to the area of interest while the motion control system is executing a predetermined scanning motion sequence.

### SUMMARY OF THE INVENTION

Ultrasonic modality non-destructive evaluation (NDE) inspection systems remotely track freestanding ultrasonic probe or transducer position relative to the inspected object without assistance or interference of an external motion control system. In some embodiments, the probe transducer includes one or more active elements for generating ultrasound waves by converting electrical energy into ultrasound wave mechanical energy (the generator), and for transmitting the ultrasonic wave thorough an inanimate non-living object. The probe transducer has one or more active elements for receiving ultrasonic echo dynamic response data (the detector). The probe/transducer optionally has an inertial G-sensor for generating movement data that are representative of transducer movement, a transducer data acquisition system for acquiring and time stamping the echo dynamic response data received from the active element detector and the movement data. In addition, a communication interface (which may be a wireless or a wired transceiver system) receives electrical energy and transmits the echo dynamic response and movement data (e.g., from the optional G-sensor) between the transducer and an ultrasonic testing instrument. In some embodiments of the invention, the wireless positioning system transmitter in or on the ultrasound probe/transducer transmits a positional signal to a single or multiple wireless receivers that are coupled to a post data processing module. In these embodiments, the transmitter is preferably integrated into the probe/transducer housing or mounted on it. The positional transmitter communicates with one or multiple known position receivers to locate the transducer's position and generate a time stamped positional data set. In other embodiments, the probe/transducer position remote tracking system is optically based, with the probe/transducer coupled to one or more reflectors that are tracked with one or more visible or non-visible wavelength cameras that generate a time stamped positional data set. In either wireless or optical remote tracking system embodiments time stamped positional data acquisition can be replaced with a commonly clocked wireless transmitter/receiver system or a commonly clocked camera image capture system. The ultrasonic testing instrument receives and processes the echo dynamic response data, creating inspection data, and transfers the inspection data to a post data processing module. The post data processing module creates a 3-D model of the inspected object, including location and size of indications in the inspected object, utilizing the inspection data and corresponding positional data received from the wireless or optical position receivers. The post data processing module may be incorporated within the ultrasonic testing system (ultrasonic testing instrument plus post data processing module) or alternatively in a separate device, such as in a personal computer or computer server. Time stamped inspection and positional data sets facilitate combining them to form a 3-D model of the inspected object. However other ways of correlating and combining the data sets other than time stamping may be used, such as by the aforementioned commonly clocked data acquisition method and system.

Embodiments of the invention feature an industrial ultrasound system for non-destructive inspection of inanimate non-living objects. The system includes a freestanding ultrasonic probe adapted for selective movement relative to a test object without assistance of an external motion control apparatus, for generating probe scan data and a remote contactless probe position tracking system, for generating probe position data. An ultrasonic testing instrument receives probe scan data and converts the scan data into inspection data. A post data processing module is coupled to the probe position tracking system and the ultrasonic testing instrument, for creating a 3-D model of the inspected object, locating and sizing indications of potential defects therein, based on the inspection and position data.

Other embodiments of the invention feature methods for non-destructive inspection of inanimate non-living objects. An ultrasound inspection system is provided, having a freestanding ultrasonic probe adapted for selective movement relative to a test object without assistance of an external motion control apparatus, for generating probe scan data. A remote contactless probe position tracking system, for generating probe position data is also provided. An ultrasonic testing instrument receives probe scan data and converts the scan data into inspection data. A post data processing module, coupled to the probe position tracking system and the ultrasonic testing instrument is also provided. The post data processing module creates a 3-D model of the inspected object, locating and sizing indications of potential defects therein, based on the inspection and position data. The method is performed by scanning a test object in real time generating scan data with the probe; tracking the probe in real time and generating probe position data with the position tracking system; and converting the scan data into inspection data with the ultrasonic testing instrument. The post data processing module then creates a 3-D model of the inspected object, locating and sizing indications of potential defects therein, using the inspection and position data.

Yet other embodiments of the invention feature industrial ultrasound systems for non-destructive inspection of inanimate non-living objects that lack known internal and external positional structural information. These ultrasound system embodiments include a freestanding wireless ultrasonic probe that is capable of free selective movement about a scanned object. The probe includes: an ultrasound generator having at least one active element for converting electrical energy to an ultrasonic wave and for transmitting the ultrasonic wave through the scanned object; an ultrasound detector having at least one active element for receiving and converting the ultrasonic echo dynamic response data to an electrical signal representative of the dynamic response data; a probe data acquisition system for acquiring the detector converted electrical energy signal from the at least one active element; and a wireless or hard wired communication system for receiving and transmitting the echo converted dynamic response electrical signals from the probe. The system embodiment includes a remote contactless probe position tracking system for generating probe position data. Alternative embodiments of the system include wireless transmission or optical position tracking systems. An ultrasonic testing instrument interfaces with the probe communication system, for receiving the converted echo dynamic response electrical signals. A post data processing module is coupled to the ultrasonic testing instrument and the probe position tracking system, for receiving the converted electrical signal echo, movement and position data, and for creating a 3-D model of the inspected object, locating and sizing indications therein

The respective features of the embodiments described herein may be applied jointly or severally in any combination or sub-combination by those skilled in the art.

### BRIEF DESCRIPTION OF THE DRAWINGS

The teachings of the invention can be readily understood by considering the following detailed description in conjunction with the accompanying drawings, in which:

FIG. 1 is a block diagram of an embodiment of an ultrasound transducer for an industrial ultrasound NDE inspection system of the invention;

FIG. 2 is a block diagram of an embodiment of an ultrasonic testing instrument of the invention;

FIG. 3 is a schematic perspective view of a first embodiment of an industrial ultrasound NDE inspection system of the invention performing an exemplary rectilinear scan;

FIG. 4 is a schematic perspective view of the first embodiment industrial ultrasound NDE inspection system performing an exemplary helical scan;

FIG. 5 is a schematic perspective view of a second embodiment of an industrial ultrasound NDE inspection system of the invention performing an exemplary rectilinear scan;

FIG. 6 is a block diagram of an alternate embodiment of ultrasonic transducer of invention;

FIG. 7 is a schematic perspective view of a third embodiment of an industrial ultrasound NDE inspection system of the invention performing an exemplary rectilinear scan; and

FIG. 8 is a schematic perspective view of the third embodiment industrial ultrasound NDE inspection system performing an exemplary helical scan.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in an industrial NDE inspection system, in which position of a freestanding ultrasonic probe or transducer relative to the inspected object is remotely tracked with a wireless transmitter/receiver or an optically based positioning system. Either type of positioning system generates a time stamped or commonly clocked positional data set that are sent to a post data processing module. The post data processing module creates a 3-D model of the inspected object, including location and size of indications in the inspected object, utilizing the positional data and inspection data generated by an ultrasonic testing instrument coupled to the freestanding probe/transducer.

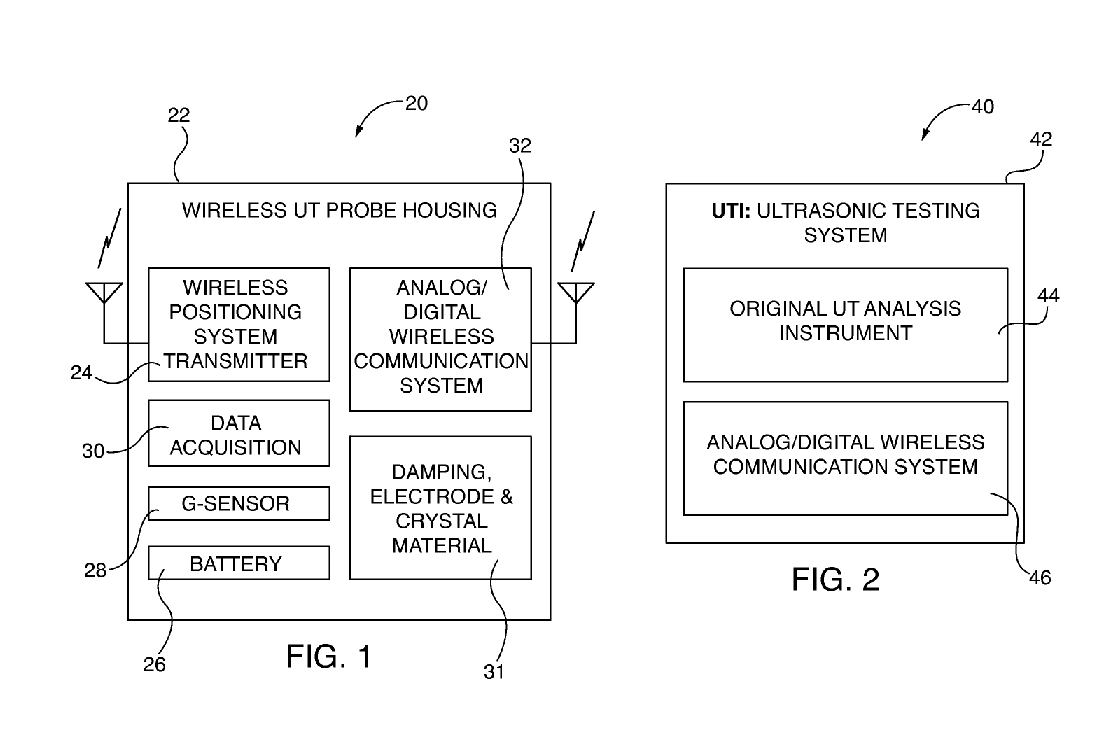

Referring generally to FIGS. 1-4, the ultrasonic inspection system has an ultrasonic probe or transducer 20 and an ultrasonic testing system (UTI) 40 that includes an ultrasound testing or analysis instrument 44 and wireless communication system 46 within UTI housing 42. The probe 20 has a housing 22, in which includes a known single or phased array transmitter and detector 31. The transmitter/detector 31 has one or more damping, electrode and crystal active elements for transmitting an ultrasonic wave thorough an object and a detector having one or more active elements for receiving echo ultrasound wave data. Echo data preferably are time stamped or sampled at a designated clock sampling rate. The probe 20 optionally includes an inertial G sensor 28 to provide movement information such as tilting, moving, skew and rotating motions. Probe movement information preferably is also time stamped or sampled at a designated clock sampling rate.

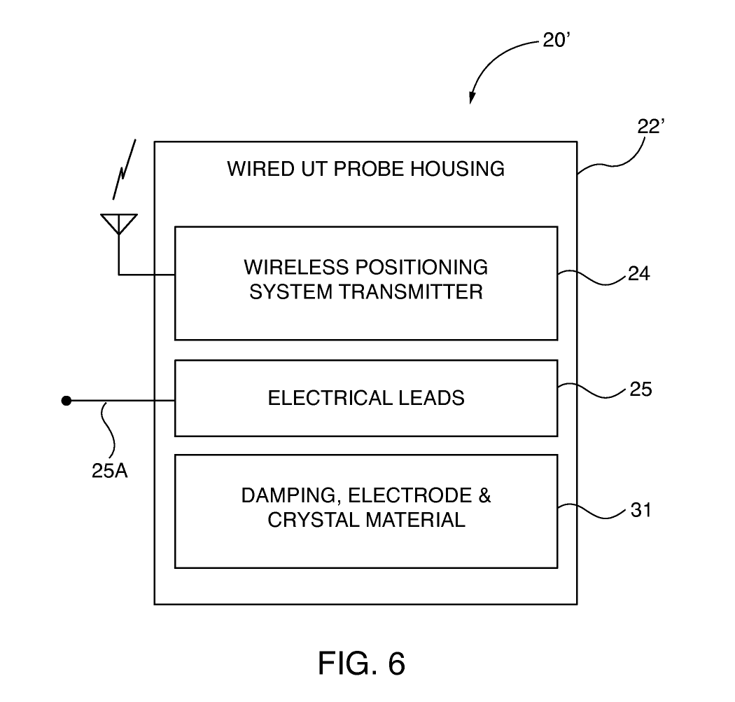

A probe data acquisition system 30 acquires and preferably time stamps or samples at a designated clock sampling rate the movement and converted echo data. The time stamped or clock sampled rate movement and echo data in either analog or digital form are transmitted to an ultrasonic testing instrument system 40/44 via an interface, such as a wireless communication system 32 or hard wired cables (see electrical leads 25 and cable 40 in the alternative embodiment probe 20′ of FIG. 6). Use of digital format would require an additional AD converter in the communication system 32. Nonlimiting exemplary formats of wireless transmission of ultrasonic echo data are radio frequency (RF), microwave or infra-red (IR) frequency.

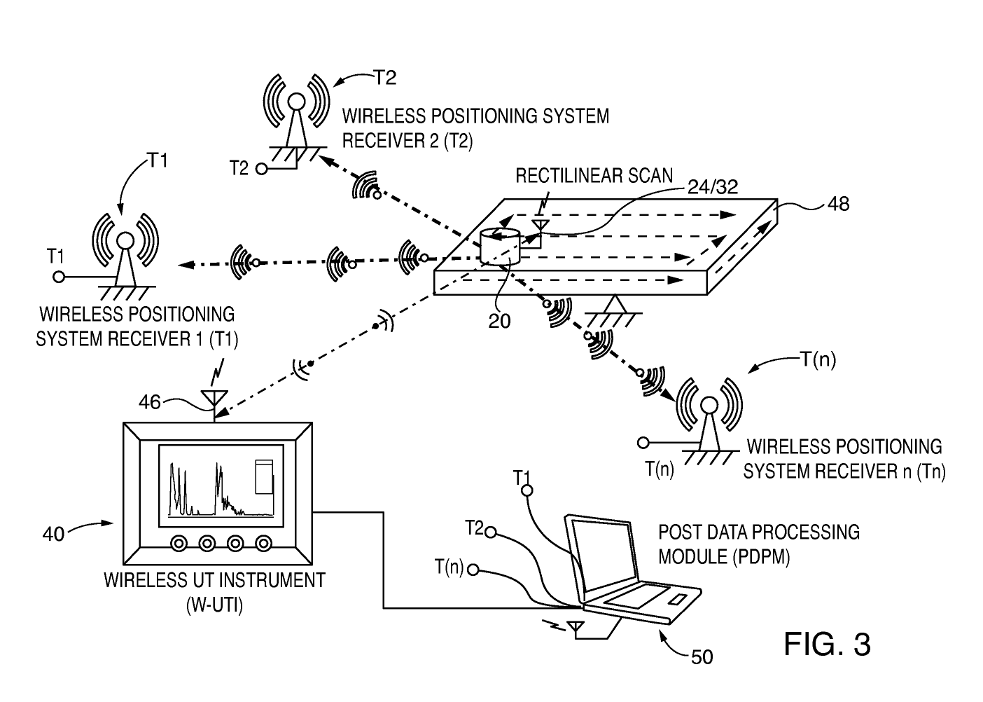

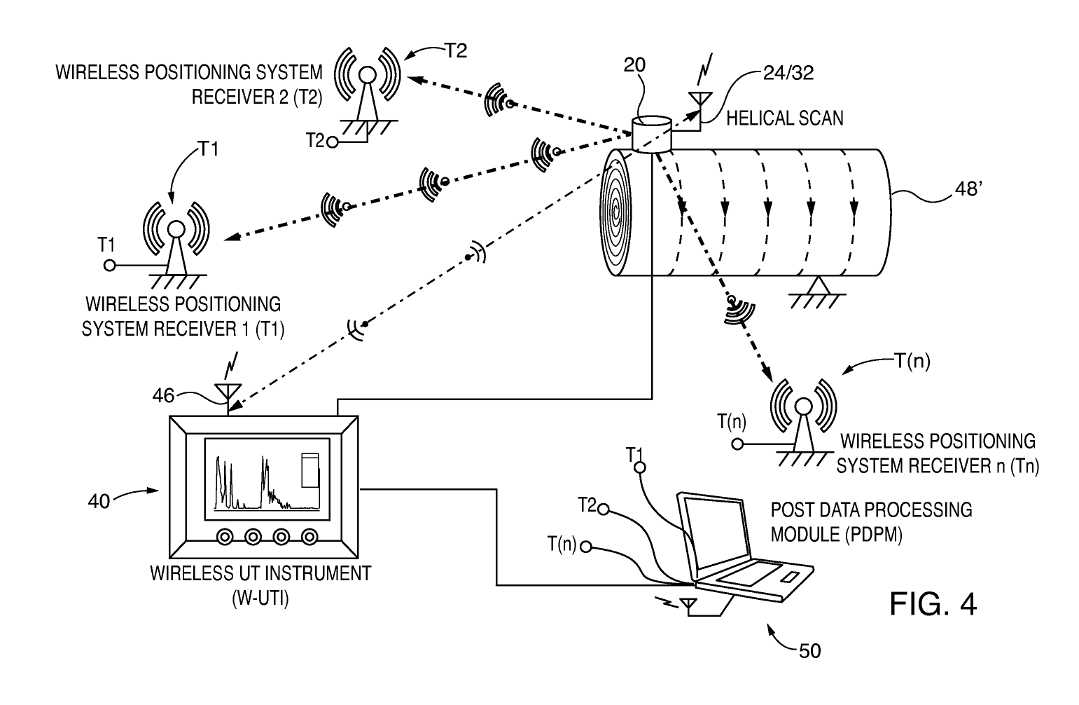

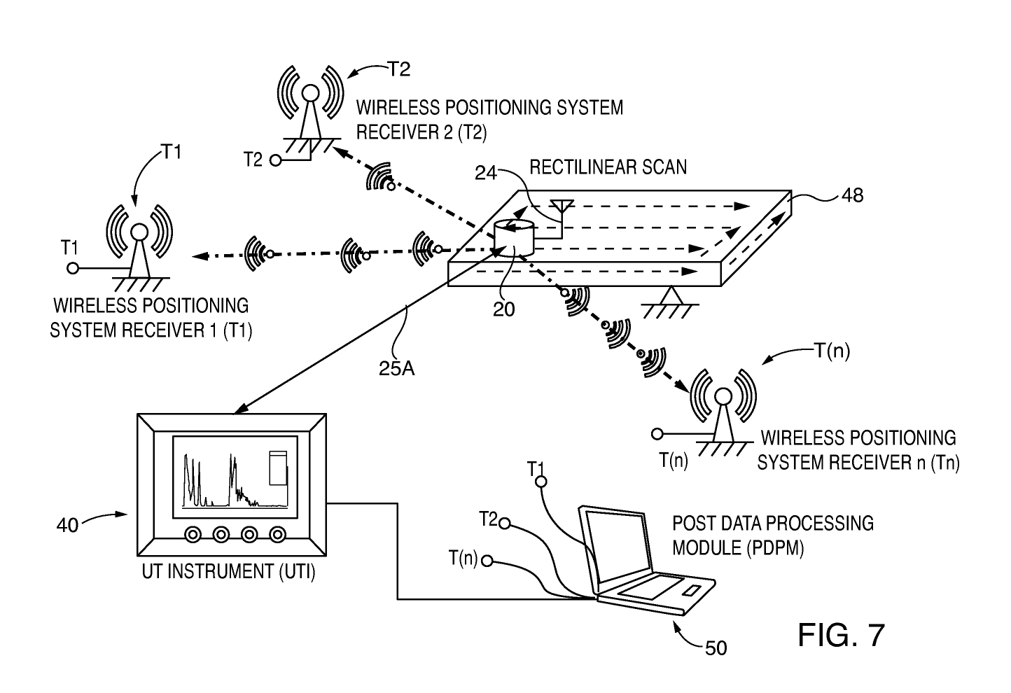

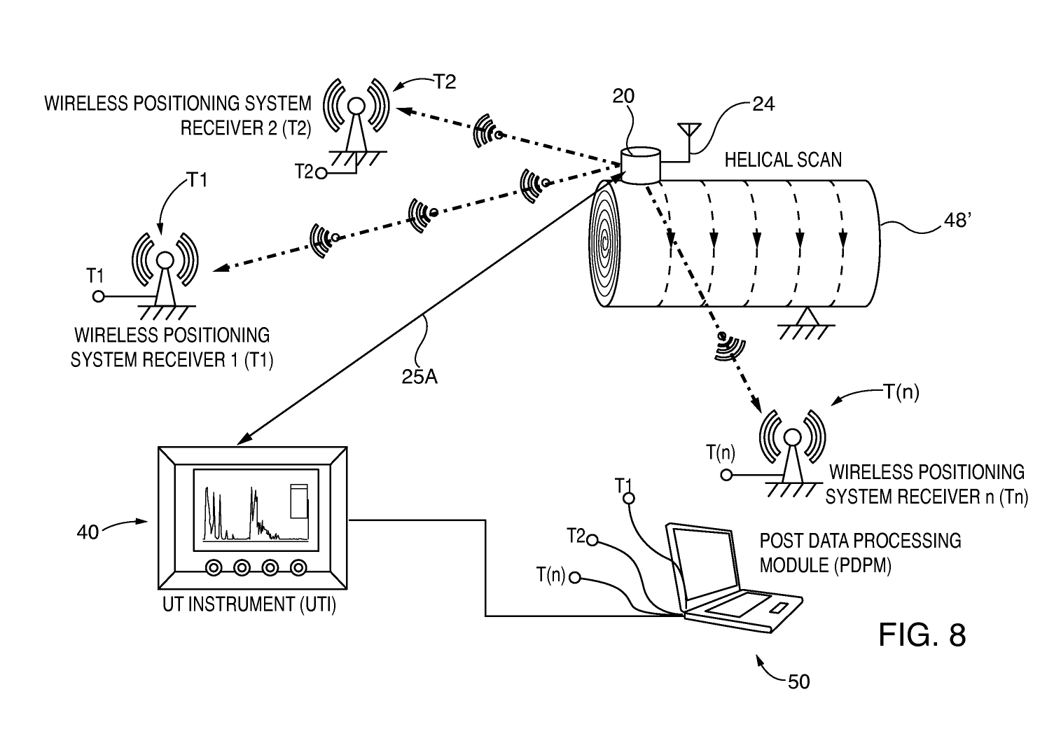

The probe 20 position relative to a test object 48/48′ is determined by a remote contactless probe position tracking system, which in various embodiments comprise a wireless or optical system. As a first part of the wireless position tracking system of FIGS. 3 and 4, the probe 20 has a wireless positioning system transmitter 24 for transmitting a transducer positional signal. The probe position tracking system also has a single or multiple wireless receivers T1-T(n) that respectively receive the positional signal(s), locate the probe 20 position and preferably generate time stamped or common clock sampling rate position data sets, as shown in FIGS. 3, 4, 7 and 8.

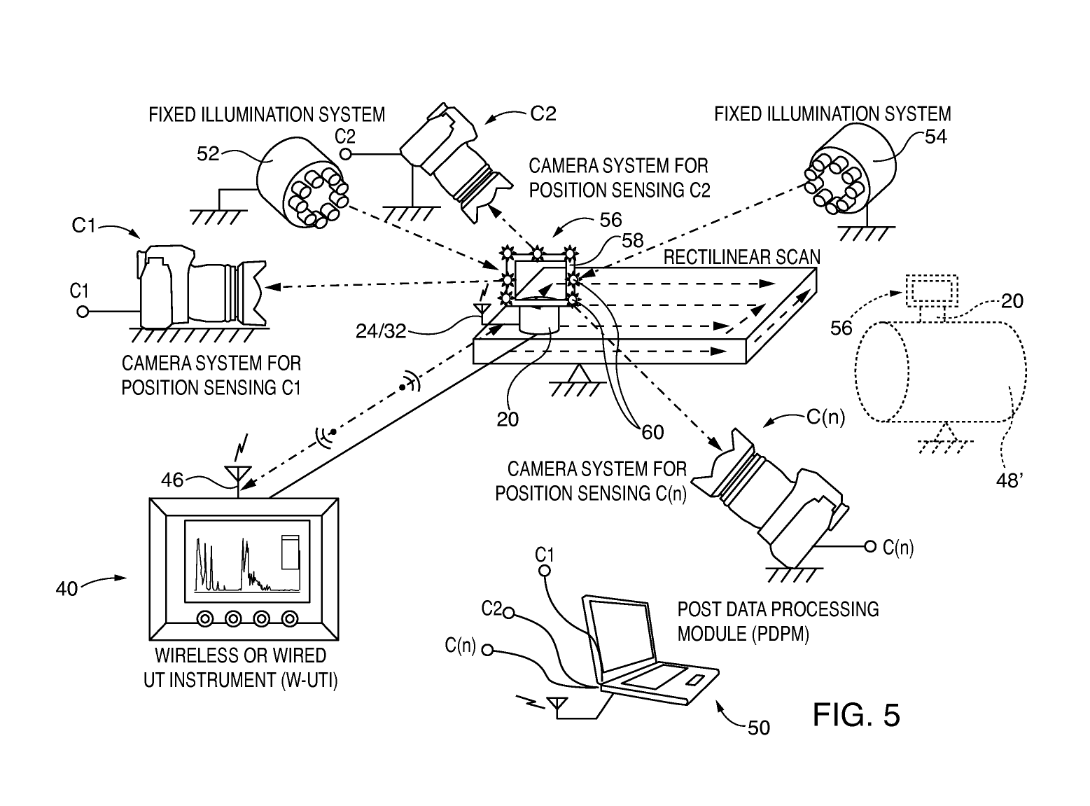

An embodiment of an optical probe position tracking system is shown in FIG. 5. The probe 20 is coupled to a probe reflector system 56, having an optical reference indicator bracket 58, onto which is affixed small reflectors 60 arrayed in a known geometric dimensional profile. These reflectors 60 are preferably illuminated by a fixed illumination system, such as the exemplary pair of light sources 52, 54. A set of two or more optical cameras, such as video cameras C1-C(n) view and record the reflector 60 positions within their respective fields of view and generate probe position data based on indicator position within the field of view. Their preferably time stamped or common clock rate sampled video data are synthesized in the post data processing module (PDPM) 50 into 3D positions of the reflectors. In this manner, the positions of the fixed reflector bracket 58, and, therefore, the coupled ultrasonic probe 20 are known.

In either wireless or optical probe position tracking systems, time stamped or common clock sample rate converted echo data (scan data), movement data and positional data sets facilitate matching of respective corresponding portions of each data set in order to associate echo scan data with a corresponding test object spatial position. However, other known parallel data stream matching techniques and methods may be substituted for time stamping or common clock sampling rate techniques. In some embodiments the positioning system will record the location of the probe 20 in a coordinate system. Other suitable exemplary implementations of the position tracking system include a laser projection system between the receiver equipment or an anchor and the probe 20 to obtain the relative positional data. Other suitable contactless probe position tracking transmission systems include aforementioned optical embodiment, as well as radio frequency (RF), microwave or infrared (IR) modalities. The remote contactless position tracking system may incorporate the probe wireless communication system 32 for transmitting echo and/or G sensor movement data to the UTI 40. It is believed that the ultrasonic probe 20 wireless positioning transmitter 24 will transmit the location to one or more positioning receivers within an accuracy of 0.5-1mm in linear direction for a single crystal UT transducer, and 0.1-0.5 mm for a phased array UT transducer.

The post data processing module 50 is coupled to the ultrasonic testing instrument (UTI) 40 and the contactless position tracking system receivers C1-C(n) or T1-T(n), and may be integrated with the ultrasonic testing instrument or incorporated within an external processing system, such as a personal computer or computer server. The post data processing module 50 receives the converted inspection data and the optional movement data from the UTI 40 and the position data from the position tracking system receivers C1-C(n) or T1-T(n) to construct 4-D ultrasonic scan results. The scan results may include the 3-D model of the inspected object, the location and size of potential defect indications in the 3-D model, and the scan patterns used to construct or derive the 3-D model/indication information.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. An industrial ultrasound system for non-destructive inspection of inanimate non-living objects, comprising:
a freestanding ultrasonic probe adapted for selective movement relative to a test object without assistance of an external motion control apparatus, for generating probe scan data;
a remote contactless probe position tracking system, for generating probe position data;
an ultrasonic testing instrument, for receiving probe scan data and converting the scan data into inspection data; and
a post data processing module, coupled to the probe position tracking system and the ultrasonic testing instrument, for creating a 3-D model of the inspected object, locating and sizing indications of potential defects therein, based on the inspection and position data.

2. The system of claim 1, further comprising:
the probe having a wireless positioning transmitter for transmitting a positional signal; and
the probe position tracking system comprising at least one wireless positioning system receiver for receiving the positional signal; locating the probe position and generating the position data.

3. The system of claim 1, further comprising:
the probe having an optical reference indicator; and
the probe position tracking system comprising at least two optical cameras respectively having fields of view that view the optical reference indicator and generate position data based on indicator position within the field of view.

4. The system of claim 3, the optical reference indicator comprising a known dimensional profile scalable by the optical cameras to derive distance from and angular orientation relative to the respective camera fields of view.

5. The system of claim 5, the optical reference indicator comprising a plurality of reflectors of known size that are arrayed in a known dimensional profile.

6. The system of claim 3, further comprising an illumination source for illuminating the optical reference indicator.

7. The system of claim 1, further comprising:
the probe scan data and position data including time stamps indicating time when the data were sampled; and
the post data processing module matching the time stamped scan and position data when creating the 3-D model.

8. The system of claim 1, further comprising:
the probe scan data and position data sampled at a commonly clocked sampling rate; and
the post data processing module using the commonly clocked scan and position data when creating the 3-D model.

9. The system of claim 1, further comprising:
an inertial G sensor, coupled to the probe and the ultrasonic testing instrument, for generating probe movement data that are representative of probe movement; and
the post data processing module also using the probe movement data to create the inspected object 3-D model.

10. A method for non-destructive inspection of inanimate non-living objects, comprising:
providing an ultrasound inspection system having:
a freestanding ultrasonic probe adapted for selective movement relative to a test object without assistance of an external motion control apparatus, for generating probe scan data;
a remote contactless probe position tracking system, for generating probe position data;
an ultrasonic testing instrument, for receiving probe scan data and converting the scan data into inspection data; and
a post data processing module, coupled to the probe position tracking system and the ultrasonic testing instrument, for creating a 3-D model of the inspected object, locating and sizing indications of potential defects therein, based on the inspection and position data;
scanning a test object in real time generating scan data with the probe;
tracking the probe in real time and generating probe position data with the position tracking system;
converting the scan data into inspection data with the ultrasonic testing instrument; and
creating a 3-D model of the inspected object, locating and sizing indications of potential defects therein, with the post data processing module, using the inspection and position data.

11. The method of claim 10, further comprising:
providing the probe with a wireless positioning transmitter for transmitting a positional signal;
providing the probe position tracking system with at least one wireless positioning system receiver for receiving the positional signal;
transmitting a positional signal with the wireless positioning transmitter while scanning the test object; and
locating the probe position with the wireless positioning system and generating the position data.

12. The method of claim 10, further comprising:
providing the probe with an optical reference indicator;
providing the probe position tracking system with at least two optical cameras respectively having fields of view that view the optical reference indicator and generate position data based on indicator position within the field of view;
viewing the optical reference indicator on the probe with the optical cameras while scanning the test object with the probe; and
generating position data with the optical cameras based on indicator position within the field of view.

13. The method of claim 10, further comprising:
time stamping probe scan data and position data; and
matching the time stamped scan and position data when creating the 3-D model.

14. The method of claim 10, further comprising:
sampling the probe scan data and position data at a commonly clocked sampling rate; and
using the commonly clocked scan and position data when creating the 3-D model with the post data processing module.

15. The method of claim 10, further comprising:
providing an inertial G sensor, coupled to the probe and the ultrasonic testing instrument, for generating probe movement data that are representative of probe movement; and
the post data processing module also using the probe movement data to create the inspected object 3-D model.

16. An industrial ultrasound system for non-destructive inspection of inanimate non-living objects that lack known internal and external positional structural information, comprising:
a freestanding wireless ultrasonic probe that is capable of free selective movement about a scanned object, having:
an ultrasound generator having at least one active element for converting electrical energy to an ultrasonic wave and for transmitting the ultrasonic wave through the scanned object,
an ultrasound detector having at least one active element for receiving and converting the ultrasonic echo dynamic response data to an electrical signal representative of the dynamic response data,
a probe data acquisition system for acquiring the detector converted electrical energy signal from the at least one active element, and
a wireless or hard wired communication system for receiving and transmitting the echo converted dynamic response electrical signals from the probe; and
a remote contactless probe position tracking system for generating probe position data;
an ultrasonic testing instrument interfacing with the probe communication system, for receiving the converted echo dynamic response electrical signals; and
a post data processing module coupled to the ultrasonic testing instrument and the probe position tracking system, for receiving the converted electrical signal echo, movement and position data, and for creating a 3-D model of the inspected object, locating and sizing indications therein.

17. The system of claim 16, further comprising:
the probe having a wireless positioning transmitter for transmitting a positional signal; and
the probe position tracking system comprising at least one wireless positioning system receiver for receiving the positional signal; locating the probe position and generating the position data.

18. The system of claim 16, further comprising:
the probe having an optical reference indicator; and
the probe position tracking system comprising at least two optical cameras respectively having fields of view that view the optical reference indicator and generate position data based on indicator position within the field of view.

19. The system of claim 16, further comprising:
the probe scan data and position data including time stamps indicating time when the data were sampled; and
the post data processing module matching the time stamped scan and position data when creating the 3-D model.

20. The system of claim 16, further comprising:
an inertial G sensor, coupled to the probe and the ultrasonic testing instrument, for generating probe movement data that are representative of probe movement; and
the post data processing module also using the probe movement data to create the inspected object 3-D model.
